(19) United States
(12) Patent Application Publication
(10) Pub. No.: US 2004/0260654 A1
(43) Pub. Date: Dec. 23, 2004

(54) Method and apparatus for selling a software product

(76) Inventor: Daniel Doll-Steinberg, Baker Street London (GB)

Correspondence Address: MORGAN & FINNEGAN, L.L.P., 3 WORLD FINANCIAL CENTER, NEW YORK, NY, 10281-2101, US

(21) Appl. No.: 10/488,605

(22) PCT Filed: Jun. 27, 2002
(86) PCT No.: PCT/GB02/02983

(30) Foreign Application Priority Data
Sep. 19, 2001 (GB) 0122602.6

(51) Int. Cl. G06F 17/60

(52) U.S. Cl. 705/55

(57) ABSTRACT

A method and system for selling a software product, and for preventing theft at the point of purchase, comprises: manufacturing a product (26), preferably at a sales outlet (20); generating a unique unlock code for the product, without which the product will not operate; displaying the product for sale at the sales outlet, while storing the unlock code separately form the product; and, on purchase of the product by a customer, supplying the customer with both the product and the unlock code. Since the unlock code is not printed onto the packaging, nor is it burned to the CD or other machine-readable media, the product can safely be left out for display and purchase in store without substantial risk of theft.

The present invention relates to a method and apparatus for selling a software product, and in particular to methods and apparatus which can protect products being displayed for sale from theft.

Products in general, and in particular games, are typically very tempting to thieves when displayed on open shelves in a retail environment. Current methods of tackling this problem to reduce “shrinkage” include displaying the products in locked glass cabinets, and displaying empty boxes with the products themselves being kept in a secure area such as a storeroom or behind the sales desk. The first approach is, however, unattractive to the customer who is unable to “browse”; while the second is unattractive to the retailer since it requires additional storage space and the time taken to match up an empty box with its corresponding product can slow down the sales process.

Another approach, which has been used with some success, is to provide a small software manufacturing facility within the retail outlet, so that software titles may be manufactured on demand. Typically, that would include a CD or DVD burner, along with a high-quality printer to print the packaging and/or a manual. On-demand manufacturing (i.e. producing the product as it is sold) does however take a little time, and customers are not always prepared to wait for the title they wish to purchase to be burned onto CD. It often proves convenient in practice for stores to bulk-manufacture at least certain titles, for example daily or weekly, and to put those pre-manufactured titles out on the shelves for customers to browse and purchase in the normal way. But in doing so, the retailer greatly increases the risk of theft or “shrinkage” of the manufactured inventory.

It is an object of the present invention at least to alleviate these problems.

It is a further object of the present invention to provide a system and method of selling a software product in which the risk of theft is reduced.

According to a first aspect of the present invention there is provided a method of selling a software product, comprising:

(a) manufacturing the product;

(b) generating a unique unlock code for the product, without which the product will not operate;

(c) displaying the product for sale at a sales outlet, while storing the unlock code separately from the product; and

(d) on purchase of the product by a customer, supplying the customer with both the product and the unlock code.

According to a second aspect, there is provided a system for selling a software product, comprising:

(a) means for manufacturing the product;

(b) means for generating a unique unlock code for the product, without which the product will not operate;

(c) storage means for storing the unlock code separately from the product, while the product is displayed for sale at a sales outlet; and

(d) means for supplying the unlock code to a customer, on purchase of the product.

Preferably, the product is manufactured at the sales outlet where it is to be displayed for sale.

The software product itself will typically comprise a CD, DVD, magnetic disk or other machine-readable media on which is stored a software title. The program is preferably so configured that it cannot be loaded, or alternatively it cannot be run, without the entry of an unlock code.

The unlock code may be generated randomly, or at least partly randomly, when the product is manufactured or is ready to be manufactured at the sales outlet. Each individual product (e.g. the content of each individual CD or DVD) is unique and as its own specific unlock code which will release only that particular copy.

When a product is purchased, the unlock code may be retrieved from a local store, printed out, and supplied to the customer in printed form. In one version of the invention, the unlock code may be printed onto an adhesive label which may then be secured to the product. This has the advantage that the adhesive label may be removed, if the product is later returned by the customer, and the same product then put back out onto the shelves for re-display and resale.

Preferably, the unlock code is stored in a database, held locally at the sales outlet. The information may be stored indefinitely if required but, preferably, to reduce local storage requirements the code may be deleted once the product has been purchased. A permanent record of the unlock code may be transmitted from the sales outlet (for example on manufacture of the product) to a remote control centre.

If an unlock code is later required, and is not obtainable in-store, the store can then send a request to the control centre for the number to be supplied; such a request may be flagged at the control centre to reduce the risk of fraud (e.g. to prevent the same unlock code being retrieved numerous times). Retrieval from the control centre is permitted only on further proof of purchase being supplied to the sales outlet staff. Any attempt to retrieve a code for an unsold product may be identified to staff.

Preferably, the software product also has a unique identifier associated with it, for example a licence number. The unlock code may be stored against a unique identifier in the local database, and also in the central database at the control centre. The databases may be interrogated, and an unlock code supplied, on the basis of a known unique identifier.

Preferably, the unique identifier is electronically stored in machine-readable form within the product, for example by burning the licence number onto a CD. The unique identifier may also be printed onto the packaging or documentation associated with the product, either in human readable form or in machine-readable form such as a bar code. Then, when an intending customer goes to the cash desk with a product for purchase, the sales assistant simply scans the bar code corresponding to the licence number, retrieves the unlock code and prints it out for supply to the customer along with the product. The sale information may then be transmitted to the control centre, which may keep track of all transactions under the system, including manufacture of products, sales, release of unlock keys, and returns.

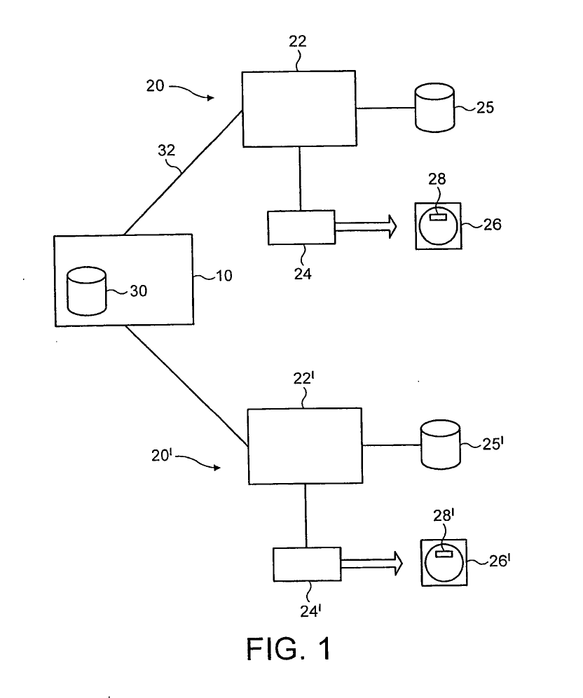

The invention may be carried into practice in a number of ways and one method and apparatus will now be described, by way of example, with reference to FIG. 1 which schematically shows the system of the preferred embodiment.

Referring to FIG. 1, a control centre 10 is in communication with a number of retail outlets 20,20′, of which only two are shown in the drawing, for clarity. Communication between the retail outlets and the control centre may be via the internet, a direct-dial telephone connection or any other convenient channel 32.

Each of the retail outlets is similar, and accordingly only the retail outlet 20 will be described in detail. The outlet 20 has a manufacturing control unit 22, typically consisting of a PC or other computer running appropriate software, and a product manufacturing apparatus 24. The latter includes a CD or DVD burner for generating the physical machine-readable product, along with printers for printing the packaging and/or a manual. The manufacturing apparatus 24 is controlled by the manufacturing control unit 22, with the data to be written to disk and the data to be printed taken from a large local hard disk drive 25 or other storage facility.

The physical system may be that described in PCT published application No WO-A-00/36536 in the name of Tribeka Limited, the text of which is incorporated by reference.

In the present embodiment, when a software product 26 is manufactured, the manufacturing control unit 22 generates an associated unique unlock code, without which the product cannot be used. A unique code is created for each individual software product that is manufactured. The unlock code is generated at least partly by means of a random number generating algorithm, to ensure uniqueness and difficulty of reproduction; it is then securely stored in a local database or the local hard drive 25, or elsewhere, linked to a product licence number or other suitable identifier. That information is also reported back to the control centre 10, where it is stored in a central database 30. Locking strength can be customised on a store by store basis with a key length of e.g. 2 to 32 characters. The character length of the release code cannot then be predicted, as it is variable.

The manufactured product 28, along with any associated packaging and manuals, can then safely be left out for display and purchase in the store. Without the unlock code (which is not burned to the disk itself, or printed out on the packaging or the manual) the disk cannot be used: it may, for example, refuse to load, refuse to run, run only for a limited time or with limited functionality. A thief who steals the disk and then attempts to bring it back to the same store, or to another, for a “refund” will not succeed since by typing in the unique licence number of the product (which is burned to the CD and printed on the packaging) the shop assistant will be able to see that that particular disk has never been legitimately purchased.

When a customer comes to the sales desk with a product, chosen from the shelves, that he wishes to purchase, the sales assistant enters the product's unique licence number and retrieves the corresponding unlock code from the local database. The unlock code is then printed out and supplied to the purchaser along with the product and the documentation. That could be done in any convenient way, for example printing the unlock code on a separate insert sheet, to be slipped inside the product casing, or as a supplement to the manual, or on the sales receipt. Alternatively, the release code could be printed onto a self-adhesive label 28 to be stuck by the sales assistant to the outside of the product packaging. The last approach has the advantage that, if the label is removable, the label can be removed and the product put back onto the shelves for resale in the event that the product is later returned by the customer. Removable labels could also be useful for retail outlets that may wish to sell second-hand titles.

Once the unlock code has been properly entered the first time the program is loaded or run by the customer, the code is then stored in encrypted form on the user's machine, from where it can be automatically retrieved when the program is run again. The unlock code thus only needs to be entered by the user once. Preferably, the key can be entered from the keyboard irrespective of Caps Lock, Control, Alt or Shift key combinations.

Once the unlock code has been retrieved from the local database for a particular product, and that product sold, the code may then be deleted from the database (to reduce local storage requirements). Because all unlock codes are held centrally at the control centre, any authorised retail outlet may have access to them, when required, and not only the store that actually made the sale. A customer who loses an unlock code could be told what the code is by presenting suitable credentials, including the product itself, at any authorised retail outlet, or by quoting a registered licence number by telephone, email, internet web site etc.

The control centre 10 monitors the entire process, and may arrange to invoice the individual retail outlets whenever a sale is made. For this purpose, a “sale” could correspond with the creation of the unlock code (in other words, the local manufacture of a product), or with the retrieval of the unlock code (in other words the actual sale of the product to a customer). The licence key never needs to be checked against any data held within the product content; and there is therefore nothing that can be intercepted by a hacker monitoring the process; the entered key is used to correct encrypted code in executable code in the software.

Preferably, products left out for display and purchase in store are marked as “protected” in some way, either on the packaging or by means of a separate notice adjacent to the display.

The process used means that code on the arrays used in store is always protected. Decoding takes place at the point of use of the software; no interception is possible whilst data is in electronic transit. Once installed, the release code can be recorded on hard disc, so that it does not need to be re-installed.

In another embodiment (not shown), the products may be manufactured at a central or clustered manufacturing facility, away from the store, with the products being shipped to the store in the normal way, pre-packaged and ready for display.

The process can be applied to Microsoft, Mac and Unix operating systems (but not limited to these three).

1. A method of selling a software product, comprising:
(a) manufacturing the product;
(b) generating a unique unlock code for the product, without which the product will not operate;
(c) displaying the product for sale at a sales outlet, while storing the unlock code separately from the product; and
(d) on purchase of the product by a customer, supplying the customer with both the product and the unlock code.

2. The method as claimed in claim 1 in which the unlock code is generated randomly.

3. The method as claimed in claim 1 in which the unlock code is printed out, and supplied to the customer in printed form, on purchase of the product.

4. The method as claimed in claim 3 in which the unlock code is printed onto an adhesive label which is secured to the product.

5. The method as claimed in claim 1 in which the unlock code is stored in a local store at the sales outlet, while the product is displayed for sale.

6. The method as claimed in claim 5 in which the unlock code is deleted from the local store on purchase of the product.

7. The method as claimed in claim 1 in which the unlock code is transmitted for storage to a remote control centre.

8. The method as claimed in claim 1 in which the software product has a unique identifier, wherein the unique identifier may be a license number, and in which the unlock code is stored against the corresponding unique identifier.

9. The method as claimed in claim 8 in which the unique identifier is electronically stored in machine-readable form within the product.

10. The method as claimed in claim 8 in which the unique identifier is printed onto packaging or documentation associated with the product.

11. The method as claimed in claim 10 in which the unique identifier is printed as a bar code.

12. A system for selling a software product, comprising:
(a) means for manufacturing the product;
(b) means for generating a unique unlock code for the product, without which the product will not operate;
(c) storage means for storing the unlock code separately from the product, while the product is displayed for sale at a sales outlet; and
(d) means for supplying the unlock code to a customer, on purchase of the product.

13. The system as claimed in claim 12 including a random number generator for at least partly generating the unlock code.

14. The system as claimed in claim 12 including means for printing out the unlock code, for supply to the customer in printed form, on purchase of the product.

15. The system as claimed in claim 14 including means for printing out the unlock code onto an adhesive label for securement to the product.

16. The system as claimed in claim 12 including a local store, at the sales outlet, in which the unlock code is stored while the product is displayed for sale.

17. The system as claimed in claim 16 including means for deleting the unlock code from the local store on purchase of the product.

18. The system as claimed in claim 12 including means for transmitting the unlock code for storage to a remote control centre.

19. The system as claimed 12 including means for creating with each software product a unique identifier, where the unique identifier may be a license number, and means for storing the unlock code against a corresponding unique identifier.

20. The system as claimed in claim 19 including means for electronically storing the unique identifier in machine-readable form within the product.

21. The system as claimed in claim 19 including means for printing the unique identifier onto packaging or documentation associated with the product.

22. The system as claimed in claim 21 including means for printing the unique identifier as a bar code.

23. The method as claimed in claim 1 in which the product is manufactured at the sale outlet.

24. The system as claimed in claim 12 in which the means for manufacturing the product is located at the sale outlet.
